(19) United States
(12) Patent Application Publication
(10) Pub. No.: US 2005/0025970 A1
(43) Pub. Date: Feb. 3, 2005

(54) Carbon beads

(76) Inventor: Bozidar Stipanovic, Lake Forest, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/730,879

(22) Filed: Dec. 8, 2003

Related U.S. Application Data
(60) Provisional application No. 60/431,371, filed on Dec. 6, 2002.
(60) Provisional application No. 60/489,048, filed on Jul. 22, 2003.

(51) Int. Cl. B32B 5/16; B32B 15/02; B32B 9/00

(52) U.S. Cl. 428/403; 432/18

(57) ABSTRACT

Carbonized cellulose beads, and methods for making and using such beads, are provided. The method includes the steps of providing reconstituted cellulose beads; drying the reconstituted cellulose beads; and pyrolyzing the reconstituted cellulose beads by heating the beads in an inert atmosphere at a temperature sufficient to pyrolyze the beads without causing significant crystallization of the beads.

### RELATED APPLICATIONS

This application claims priority under 35 U.S.C. §119(e) to U.S. Provisional Patent Application No. 60/431,371, filed on Dec. 6, 2002, and U.S. Provisional Patent Application No. 60/489,048, filed on Jul. 22, 2003, both of which are incorporated herein by reference in their entireties.

### FIELD OF THE INVENTION

The present invention is directed to carbon beads. The present invention is further directed to methods for making and using carbonized cellulose beads. More specifically, the invention is directed to carbonized beads for use as an electrode material in lithium-ion batteries.

### BACKGROUND

Advanced portable electronics such as cellular phones, notebook computers, and military and civilian field and marine navigational and positioning systems require dependable batteries that can provide high energy density and reversibility. A typical lithium-ion battery system is made up of a graphite anode, a non-aqueous organic electrolyte that separates and conducts ions between two electrodes in which lithium salts such as LiAsF₆ and LiPF₆ are dissolved, and finally, a lithium metal oxide (such as LiMn₂O₄ or LiCoO₂) cathode. Such a battery works based on a simple reversible electrochemical reaction: in the charging mode, positive lithium ions migrate through the electrolyte to the graphite anode; during the discharge mode, the lithium ions flow back to the cathode.

The gain in popularity of lithium-ion batteries is largely due to their high energy density and high voltage. Lithium-ion batteries can provide close to 3.7 volts, three times the voltage provided by nickel batteries. Another benefit is that, unlike nickel batteries, lithium-ion batteries do not display the memory effect. The memory effect occurs when a battery is charged before it has been completely discharged, causing the amount of energy the battery can store to be decreased.

Efforts to improve lithium-ion batteries are ongoing and are focused in various directions including: (a) studying and understanding functional mechanisms of electrochemical reactions, including their thermodynamic and kinetic aspects; (b) tailoring new electrode materials, for both anodes and cathodes; (c) modifying electrode surfaces; and (d) searching for electrolytes with improved properties, effectiveness, and stability. The ultimate, long term, goal of the lithium-ion battery industry is in to provide power sources for new markets for large-scale users, such as electric vehicles. Before such uses can materialize, however, it will be necessary to further improve the capacity and stability of lithium-ion batteries, and to address safety concerns.

Among the new materials for use in electrochemical processes related to generating (e.g., fuel cells) and storing (e.g., batteries, capacitors, electrolytic super-capacitors, etc.) electrical energy, carbon plays a prominent role. Simultaneously, carbon serves as a conductor and a host-carrier of metals, metal alloys, metal oxides, and their respective nanoclusters. In addition, a variety of composites of carbons, such as double-layer materials and redox pseudocapacitive organic (polypyrol, polyaniline, polyphenylene vinylene, etc.) and inorganic (ruthenium oxide) materials, have been reported. Recently a new type of anode, based on a carbon-carbon composite, was developed (see Hossain et al., Journal of Power Sources, 96: 5-13 (2001)). The carbon-carbon composite offers many advantages such as high reversible capacity, low capacity loss on recycling, and good electrical and thermal conductivities.

At present, there is no standard grade of carbon or graphite materials for energy-related electrochemical processes. The choice of carbon materials is based on commercial availability and on specific requirements for a given application, such as surface area, morphology (fibers, spherules, flakes, nanotubes), voltage profile, and cycling reversibility. For example, recent progress in the development of lithium-ion batteries has involved the use of carbons derived by carbonization of a variety of precursors ranging from sucrose and cotton fabrics to petroleum pitch and gaseous hydrocarbons, such as propylene and paraphenylene pyrolyzed within inorganic templates.

Amorphous carbon spherules having an average diameter of 6 to 8 microns and a B.E.T. surface area of about 400 m²/g (Brunner Emmet Teller method for measuring surface area) were made by carbonizing sucrose. (Li, H., Wang, Q., Shi, L., Chen, L., and Huang, X., Nanosized SnSb Alloy Pinning on Hard Non-Graphitic Carbon Spherules as Anode Materials for a Li Ion Battery, Chem. Mater., 14(1): 103-108 (2002)). The relatively large surface area is the result of micro-porosity on the bead surface (as observed by high-resolution transmission electron microscopy (HRTEM)) with typical pore diameters of 4 to 8 Angstroms. When tin-antimony (β-SnSb) alloy particles were pinned onto the surface of these beads, the grain sizes of the alloy particles had an average diameter of 100 nm. Individual nano-clusters of about 25 nm in diameter were observable under scanning electron microscopy (SEM). The weight percent of tin (Sn), antimony (Sb), zinc (Zn), and carbon (C) in the composite spherule were 13.2%, 16.5%, 1% and 70.3%, respectively. Calculated atomic composition of a composite spherule and scanning electron micrographs clearly indicate that only the outer surface of the composite participates in electrochemical insertion of lithium atoms into the SnSb alloy. The interior of the carbon spherule contains a large void volume, comprising a network of tiny micropores that cannot be electrochemically active.

There remains a need for anode materials with improved stability, safety, and lithium storage capacity.

### SUMMARY

Carbonized cellulose beads, and methods for making and using such beads, are disclosed. More specifically, carbon beads, and methods for making carbon beads, for use as a lithium anode material are disclosed.

In one embodiment, the invention is directed to improved carbonized cellulose beads. In another embodiment, the invention is directed to a method for producing carbonized cellulose beads, the method including the steps of providing reconstituted cellulose beads; drying the reconstituted cellulose beads; and pyrolyzing the reconstituted cellulose beads by heating the beads in an inert atmosphere at a temperature sufficient to pyrolyze the beads without causing significant crystallization of the beads.

The invention can best be understood with reference to the following detailed description of the preferred embodiments in conjunction with the accompanying drawings. The discussion and examples below are descriptive and illustrative, and are not intended to limit the scope of the invention as defined by the appended claims.

### BRIEF DESCRIPTION OF THE DRAWINGS

FIG. 1 is a schematic representation of one embodiment of a horizontal flow type apparatus which can be used for carbonizing cellulose beads.

FIG. 2 contains scanning probe micrographs of Orbicell® cellulose beads and of carbonized Orbicell® cellulose beads pyrolyzed as described in Example 1. FIG. 2A is a scanning probe micrograph of untreated Orbicell® cellulose beads at a magnification of 6470 times. FIG. 2B is a scanning probe micrograph of carbonized Orbicell® beads at a magnification of 5000 times. FIG. 2C is a scanning probe micrograph of carbonized Orbicell® beads at a magnification of 65,000 times. FIG. 2D is a scanning probe micrograph of carbonized Orbicell® beads at a magnification of 150,000 times.

FIG. 3 is a schematic representation of a carbon tin-antimony alloy spherule.

### DETAILED DESCRIPTION OF THE PREFERRED EMBODIMENTS

The present invention provides micron-sized amorphous carbon spherules. Microspherical particles made of reconstituted cellulose are preferably used as precursors for making micron-sized, high quality, amorphous carbon spherules having a very narrow size distribution ranging from about 0.6 to about 2 microns and having a large surface area. In a preferred embodiment, Orbicell® beads, available from APL Biopurification Technologies (Highland Park, Ill.) are used to make the carbonized beads of the present invention. Orbicell® beads are described in U.S. Pat. No. 5,656,373, which is incorporated herein by reference in its entirety.

Briefly, Orbicelle® beads are small, reconstituted cellulose particles with substantially no surface pores and with low non-specific binding properties. The cellulose particles are small, substantially spherical bodies with very few surface irregularities. The cellulose particles are made from viscose, yielding uncross-linked, high density, spherical cellulose beads without substantial holes, cracks, voids, or craters on their surfaces. Microspherical particles with diameters close to 1 micron and with a very narrow size distribution are preferably used to make the carbonized beads of the present invention. The cellulose beads are not composed of gel, but of very hard cellulose material with nano-sized closed-cell type pores in the interior of the bead, wrapped in a continuous, egg shell-like skin. The cellulose beads are essentially non-crystalline with a dense non-porous outer shell and an interior containing closed-cell type pores.

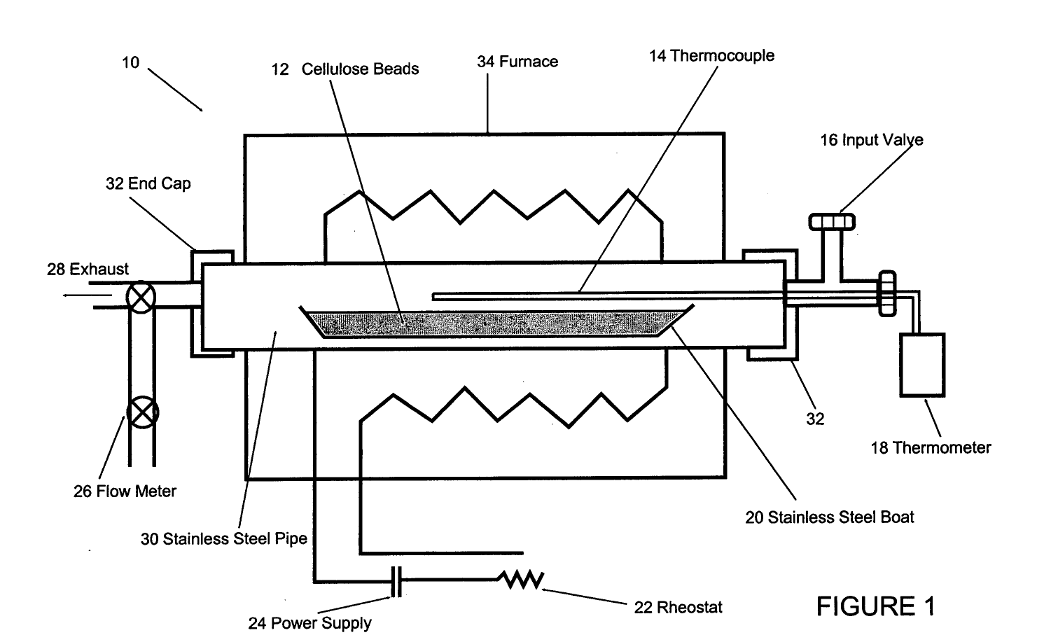

According to the present invention, cellulose beads undergo controlled dehydration and carbonization in an inert atmosphere. While it is possible to practice the present invention with other types of cellulose beads, Orbicelle® beads are preferred due to their small size, relatively uniform size distribution, and nonporous, amorphous structure. The pyrolytic process of cellulose carbonization can be carried out in any type of furnace apparatus that can be heated to an appropriate temperature and swept with an inert gas. Examples of furnace apparatuses that can be used include a horizontal flow type apparatus, as shown in FIG. 1, or a fluidized bed type apparatus. While the beads are being heated, the system is flushed with an inert gas, such as nitrogen or argon, to keep the atmosphere inert and oxygen free. The inert atmosphere allows pyrolysis of the beads, or removal of hydrogen, water, and other components, without significant removal of carbon.

Before pyrolysis, the beads are preferably dried by an azotropic evaporation process to remove excess water. The dried beads are heated at a temperature and for a time sufficient for pyrolysis. The beads start to pyrolyze at temperatures above about 200° C. Preferably, the temperature should not be maintained over about 650° C. because the carbon will begin to crystallize and form graphite at temperatures between about 700° C. and about 800° C. It is preferred to maintain the amorphous, non-crystallized morphology as found in the cellulose beads from which the carbonized beads are formed.

The rate of pyrolysis is preferably controlled so that the rate of production of decomposition products is not too great. If pyrolysis occurs too quickly, the decomposition products can cause various problems such as clogging the furnace system or causing the beads to agglomerate. The flow rate of the inert gas and the heating temperature can be adjusted to control the rate of pyrolysis and the rate of production of decomposition products. Generally, the inert gas will be streamed through the furnace at a higher rate at the beginning of the process when the highest rate of decomposition products are being produced.

Preferably, the beads are substantially completely carbonized, as the more complete the carbonization, the better conductive properties the beads will have. The resulting carbonized beads are conductive, amorphous carbon spherules, with equal or slightly smaller diameters than the starting cellulose beads (about 0.6 to 2 microns), with densities less than about 2, possessing high strength and integrity, and capable of withstanding high pressures and wear. The carbonized beads of the present invention are smaller than typical 6 to 8 micron cellulose beads, and therefore have a relatively very large surface area. They are light, with a specific gravity of less than about 2. They appear to maintain the morphology of the original cellulose, with a nonporous surface and an interior containing closed cell type pores, thereby eliminating excess weight without affecting the strength of the beads. Preferably, the carbonized beads also have a relatively narrow size distribution (like the Orbicell® beads that can be used as a starting material) and not many fines, or particles much smaller than the beads that can fill the interstitial spaces between the beads.

The carbonized cellulose beads can be used in a wide array of applications. The beads can be used as manufactured in making electrodes for batteries, fuel cells, etc. Cellulose-derived carbon materials possess outstanding physical properties that are in demand for many advanced technological applications. For example, rayon filaments, produced from viscose (the same starting material as that used to make Orbicell® beads) are used in fabricating carbon fibers utilized in winding the cones for the space shuttle's rocket engines. Carbonized cellulose beads can be made for use in place of carbonized rayon filaments in these types of applications. The procedures that NASA uses for carbonizing rayon filaments for manufacturing carbon fibers can be modified to fit production of microspherical amorphous carbon particles (e.g. using a fluidized bed).

In one preferred embodiment, carbonized cellulose beads according to the present invention are used in lithium-ion battery systems. In lithium-ion batteries, it is advantageous to use various carbon materials as anode electrodes in order to circumvent the tendency of metallic lithium to grow dendritically during the charging mode, which negatively affects the life and reliability of a cell. However, the use of traditional carbon materials as an anode may lower the specific energy density of a cell due to limited lithium uptake into the carbon matrix. One advantage of the carbonized beads of the present invention is their relatively small size and relatively very large surface area, providing greater capacity for lithium uptake.

In another embodiment, the carbonized cellulose beads according to the present invention can be treated to impart different properties to their surfaces such as hydrophilicity or the introduction of surface functional groups. The beads can be modified by the addition of nanoclusters of metals, metal alloys, metal oxides, or other materials pinned to the carbon surface of the pyrolyzed beads. A variety of metals (noble metals, early and late transition metals, and their alloys), inorganic materials (metal oxides, metal complexes, non-metallic compounds, etc.), and organic compounds (conjugated and doped conductive polymers, biomolecules, etc.) can be used. Examples of materials that can be added to the surface of the carbon beads depending on the desired characteristics include, but are not limited to, platinum (Pt)(particularly for catalysis and for fuel cells), rhodium (Rh), palladium (Pd), nickel (Ni), and cobalt (Co).

Precipitation of nanomaterials can be accomplished with various reactions, from electroless chemical redox reactions to electrochemical deposition, with sol-gel nano-coating methods, and by polymerization and self-assembly of appropriate monomers, for example. (Li, H., Wang, Q., Shi, L., Chen, L., and Huang, X., Nanosized SnSb Alloy Pinning on Hard Non-Graphitic Carbon Spherules as Anode Materials for a Li Ion Battery, Chem. Mater., 14(1): 103-108 (2002)).

Metal based nanomaterials can be obtained by various gas-phase processes, as well as by reactions in solution. Generally, late transition metal nanoparticles, due to their positive standard potentials, can be formed reductively by reacting mild reducing agents, such as sodium citrate, with metal complexes. On the other hand, nanocluster synthesis from early transition metals, with negative standard potentials, require strong reducing agents, such as alkali and alkaline earth metals, metal hydrides or electrides, to reduce the metal complexes. As a substitute for one of the strong reducing agents, SiH₄ (a highly pyrophoric compound), compounds such as Si[Si(CH₃)]₄ (where the Si(CH₃) group can be viewed as a “pseudo-hydrogen”), may be used effectively to reduce metal complexes into nanoclusters of their respective metals. In a similar fashion [Si(CH₃)₂]₆ and sylylene can also be used as reductants.

Carbon nanotubes can be grown on carbonized Orbicell® beads using the methods described in the art. (H. Hou, and D. H, Reneker, Polymer Preprints, 44(2): 63 (2003)). A dense array of formed nanotubes may effectively “lock” the beads to each other and thereby sufficiently immobilize them, creating a carbon film that may be used for lithium battery anodes.

These are just a few of the reactions that can be used to pin a variety of nanomaterials onto the surface of the carbon beads. These examples serve as illustrations of a wide spectrum of unmodified and modified carbon materials, with diverse physical and chemical properties that make the carbonized cellulose beads of the present invention useful in numerous applications such as storing and generating energy, storing gases (hydrogen, in particular, for fuel cell energy generators), catalysis, tribology, etc.

### EXAMPLE 1

### Carbonization of Cellulose Beads

This example describes the carbonization of Orbicell® cellulose beads. The pyrolytic process of cellulose carbonization is accomplished in a horizontal flow-type apparatus (10) as shown on FIG. 1. The apparatus consists of a 14 inch long stainless steel pipe (30) with a 1½ inch internal diameter inserted into a horizontal tube furnace (34). The temperature is controlled by a rheostat (22). Dry nitrogen gas is streamed through an input port (16) into the furnace to maintain an inert, oxygen-free environment.

28 grams of dried Orbicell® cellulose beads (12), with an average diameter of 1 to 3 microns, are placed onto a stainless steel boat (20). The end caps (32) are closed, and then the entire system is purged with dry nitrogen gas. The heating starts at approximately 30% of the full voltage. When the temperature reaches about 230° C., the nitrogen flow is about 150 ml/min, and the system is kept at these conditions for about 24 hours. The temperature is then increased to about 358° C. for about 20 hours. Next, the nitrogen flow is lowered to about 90 to 100 ml/min, and the temperature is raised to about 435° C. and maintained for about 14 hours. For the next about 8 hours, the temperature is raised and maintained at about 475° C., and the nitrogen flow is kept at about 90 to 100 ml/min until the end of the experiment. For the next about 14 hours, the temperature is kept at about 540° C. For the last two periods of heating, the temperature is maintained at about 612° C. and about 648° C., for about 6 and about 12 hours, respectively. The heating is then discontinued, and the pyrolysis tube is cooled down under the flow of nitrogen before it is opened.

The resulting carbon beads are slightly agglomerated, but can be easily separated by gently grinding in a mortar and pestle. The beads are very light and easily dispersible in organic solvents such as acetone, alcohol or tetrahyrofurnane. The sedimentation of the beads is very slow, and it takes more than 24 hours for the carbon beads to settle out of acetone. This behavior indicates that the interior of the beads is not solid, but contains the same system of small, closed-cell type voids that are present in the precursor cellulose beads. The surface area of tapped beads is about 2.25 m/ cm³ or about 4 m/g, and the apparent density is between about 0.56 g/cm³ and about 0.58 g/cm³.

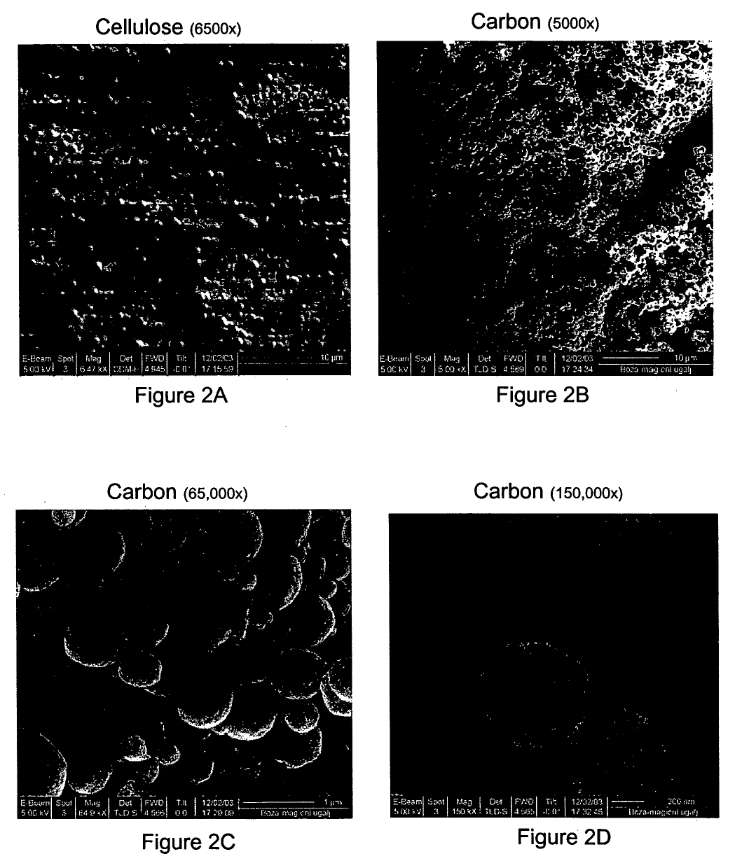

Beads produced according to the method described in this example were analyzed using scanning probe microscopy as shown in FIG. 2. FIG. 2 contains scanning probe micrographs of Orbicell® cellulose beads and of carbonized Orbicell® cellulose beads made according to the procedure set forth in this example. FIG. 2A is a scanning probe micrograph of untreated Orbicell® cellulose beads at a magnification of 6470 times. FIGS. 2B, 2C, and 2D are scanning probe micrographs of carbonized Orbicell® beads at magnifications of 5000 times, 65,000 times, and 150,000 times, respectively. As seen in the micrographs, the surface of the carbonized beads appears to be nonporous and substantially free from surface irregularities, like the Orbicell® bead precursors. The resulting carbonized beads are small, approximately 0.6 to 2 micron beads with a large surface area. They are light, with a specific gravity of less than about 2, possibly about 1.5 or less, due to the internal closed-cell pore structure. And they have a substantially non-porous surface like the cellulose bead precursors.

### EXAMPLE 2

### Carbon Tin-Antimony Alloy Beads

The carbonized microspherical beads made of reconstituted cellulose, such as Orbicelle® beads, can also be modified by adding metals, metal alloys, or metal oxides to the surface. In one such application, nano-sized clusters of SnSb alloy, which possesses a very high lithium storage capacity, are pinned onto the surface of the carbon spherules. Individual SnSb alloy nano-clusters have a propensity to agglomerate upon lithium metal insertion; therefore, the process of pinning nanoclusters onto the solid surface of the bead can effectively eliminate the mobility of the clusters, and consequently eliminate the agglomeration phenomena.

β-SnSb single-phase nanocrystals pinned onto a carbon surface undergo transformation into a multiple-phase material, Li₃Sb and LiₓSn (x<4.4), during insertion of lithium atoms. This reversible structural variation leads to better cyclic performance of the battery.

Carbonized Orbicelle® beads accommodate the attachment of nascent metal, metal-alloy or metal oxide nanoclusters. Alloy-nanoclusters on Orbicell® carbon material are immobilized, thereby effectively preventing them from coalescing into a bulk-type material, which causes the nanomaterials to lose their desired properties. Due in part to their morphology and greater surface area, there are substantial advantages to using the carbonized beads of the present invention for such applications.

For purposes of illustration, the theoretical surface area in m²/cm³ and in m²/g of traditional carbon spherules having an average diameter of 6 to 8 microns (Hard Carbon Spherule or HCS) and Orbicelle® Carbon Beads (OCB) are compared.

Surface Area or sphere=12.57×r², where r=radius of a sphere
r_{HCS}=3.5 microns
r_{OCB}=0.75 microns
Surface Area (A) expressed in (m²/cm³) or (m²/g¹)
   A_{HCS}=0.852 m²/cm³ or 0.426 m²/g¹
   A_{OCB}=3.973 m²/cm³ or 1.987 m²/g¹
   A_{OCB}/A_{HCS}=3.973/0.852 or (1.987/0.426)=4.66

As shown above, Orbicelle® carbon beads have a calculated theoretical surface area approximately 4 to 5 times greater than the corresponding surface area of the hard carbon spherules known in the art. The density of the hard carbon spherules was determined to be about 2 g/cm³. For the sake of comparison only, an equal density for Orbicelle® carbon beads will be assumed. The actual density of the Orbicelle® carbon beads OCB particles is probably lower than 2 due to the existence of closed-cell type pores within the interior of the beads which appears to survive the pyrolytic process.

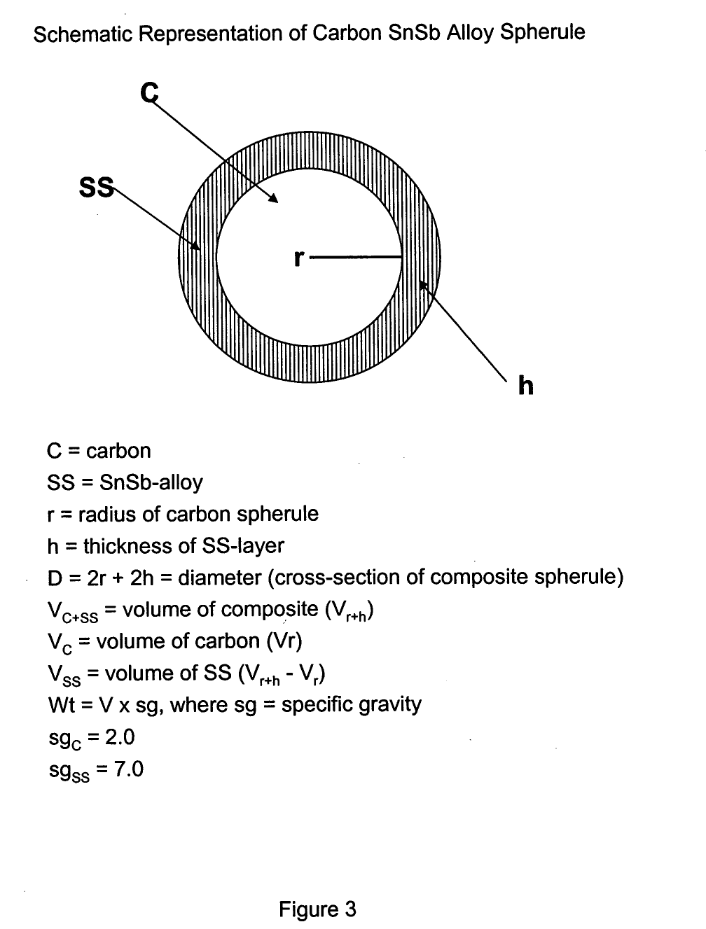

From the percent composition of the composite “HCS+SS” (“Hard Carbon Spherule+SnSb alloy”) and from the calculated composition of “OCB+SS” (“Orbicelle® Carbon Bead+SnSb alloy”) as well as from the density of amorphous carbon (d_{C}=2.0), the density of SnSb alloy (d_{SS}=7.0), and from the thickness of the SnSb alloy cluster layer, estimated to be about 100 microns by scanning electron microscopy(SEM), the following values for dimensions and mass of the respective spherical particles are computed as shown in Table 1. A schematic representation of a carbon-SnSb-alloy spherule is illustrated in FIG. 3.

TABLE 1
Comparison of Hard Carbon Spherule-SnSb Alloy
and Orbicell ® Carbon Bead-SnSb Alloy

| | HCS + SS | | OCB + SS | |
|---|---|---|---|---|
| D | 7.2 | μm | 1.7 | μm |
| r | 3.5 | μm | 0.75 | μm |
| h | 0.1 | μm | 0.1 | μm |
| Vᵣ | 1.796 × 10⁻¹⁰ | cm³ | 1.77 × 10⁻¹² | cm³ |
| Vᵣ₊ₕ | 1.954 × 10⁻¹⁰ | cm³ | 2.57 × 10⁻¹² | cm³ |
| V_{SS} | 1.580 × 10⁻¹¹ | cm³ | 8 × 10⁻¹³ | cm³ |
| Wt_{HCS} or Wt_{OCB} | 3.592 × 10⁻¹⁰ | g | 3.54 × 10⁻¹² | g |
| Wt_{SS} | 1.106 × 10⁻¹⁰ | g | 5.6 × 10⁻¹² | |
| Wt_{HCS+SS} or Wt_{OCB+SS} | 4.698 × 10⁻¹⁰ | g | 9.14 × 10⁻¹² | g |

| | | |
|---|---|---|
| % SnSb alloy | 23.54% | 61.27% |

C=carbon
SS=SnSb-alloy
r=radius of carbon spherule
h=thickness of SS-layer
D=2r+2h=diameter (cross-section of composite spherule)
V_{C+SS}=volume of composite (Vᵣ₊ₕ)
V_{C}=volume of carbon (Vᵣ)
V_{SS}=volume of SS (Vᵣ₊ₕ−Vᵣ)
sg=specific gravity
Wt=V×sg
sg_{C}=2.0
sg_{SS}=7.0

As shown in Table 1, the amount of SnSb-alloy in the HCS+SS composite is calculated to be 23.54%, and the amount of SnSb-alloy in the OCB+SS composite is calculated to be 61.27%. The substantially larger amount of SnSb alloy in the OCB+SS composite allows for greater lithium storage capacity.

For building monolayers (ML) from the respective carbon-SS-alloy composites, one can calculate (using the values given above) and compare their capacities for lithium intercalation.

TABLE 2
Monolayer (ML) Capacities

| | HCS + SS | | OCB + SS | |
|---|---|---|---|---|
| Cross-section (D) | 7.2 | μm | 1.7 | μm |
| Area occupied by single | 51.84 | μm² | 2.89 | μm² |
| spherule (D²) | | | | |
| No. of spherules in 1 | 1.93 × 10⁶ | | 34.6 × 10⁶ | |
| cm² of a ML | | | | |
| Weight of SS alloy per 1 | 2.135 × 10⁻⁴ | g | 1.938 × 10⁻⁴ | g |
| cm² of ML | | | | |
| (Wt_{SS}/cm²/ML) | | | | |

As shown in Table 2, 1 cm² of a monolayer (ML) of OCB+SS has only about 10% less SnSb-alloy than the same square area of the HCS+SS composite particle monolayer. At the same time, the thickness (1.7 micron) of the OCB+SS reaches only about 25% of the thickness of the HCS+SS (7.2 microns). Since single-phase β-SnSb alloy is transformed into multiple phases of Li₃Sb and LiₓZn (x<4.4) during lithium insertion and is restored as a single phase upon lithium extraction during the discharge cycle, it can be assumed that the weights of the SnSb alloy in the anode films are proportional to their respective capacities to incorporate and hold lithium.

Translated into a lithium anode construction, these values reveal a clear advantage that the about 1 to about 2 micron Orbicell® carbon beads hold over larger 6 to 8 micron carbon spherules. In order to build anodes of equal thickness out of carbon-SnSb alloy composite particles, tightly packed in the form of a film on a metal, usually copper foil, it is required to deposit more than 4 monolayers of OCB+SS per each monolayer of HCS+SS (as calculated from their respective cross-sections of 7.2 and 1.7 microns).

For purposes of illustration only, if a 50-micron thick anode is required, the following calculations apply:
HCS+SS: 7 MLs at 7.2 microns/ML=50.4 microns
OCB+SS: 30 MLs at 1.7 microns/ML=51.0 microns

For a 1 cm² area of anode film made out of 7 MLs of HCS+SS and 30 MLs of OCB+SS, the anodes will contain 1.7 mg and 5.8 mg of SnSb alloy, respectively. From the ratio of 5.8/1.7=3.4, it follows that the capacity to store lithium, as compared at equal thicknesses of the respective anodes, is about 3.4 times greater for Orbicell® carbon beads than for spherules of about 6 to 8 microns. Another advantage of Orbicell® carbon beads relates to their very narrow particle size distribution. Even when tightly packed in multilayered, thick films used in construction of lithium anode electrodes, there is a presence of an interstitial void network, unobstructed by fines, allowing easy access and transport of lithium to the surface of the carbon SnSb alloy composite particles. Additionally, the immobilized nanoclusters of metals, metal alloys, metal oxides, etc., are prevented from agglomerating upon cycling of electrochemical, catalytic, redox or other chemical transformations, thereby retaining their unique properties characteristic of nanomaterials.

### EXAMPLE 3

### Anodes for Lithium-Ion Batteries

Carbon beads, such as carbonized Orbicell® beads can be used as anode materials in lithium ion batteries. Improved anodes based on carbonized cellulose beads according to the present invention, coupled with latest advances in designing cathodic materials can raise the reliability, capacity, and safety of lithium-ion batteries. Carbon-carbon composite anodes, incorporating Orbicell® carbon beads can increase the surface area of the anode approximately 3 to 4 times without loosing any of the advantages of using carbon-carbon composite materials.

One preferred embodiment of a lithium-ion battery using a carbon bead anode material utilizes a lithium-iron phosphate cathode. In cathodes using lithium-iron phosphate, the material's low conductivity, which precluded its use in commercial lithium-ion batteries, was dramatically improved by doping the lithium-iron phosphate. The electronic conductivity of the doped material was increased some 10 million times over undoped lithium-iron phosphate, placing it in the same league with conventional, but much more expensive and sometimes, unstable cathode materials.

### EXAMPLE 4

### Anodes for Magnesium-Ion Batteries

Analogous to other types of batteries, like lithium-ion batteries, the conductivity of an anode material and the accessibility of electrolyte to its surface are both important factors in a battery's efficiency. Carbonized cellulose beads according to the present invention can play a beneficial role in the construction of not only lithium-ion batteries, but other types of batteries as well, including magnesium-ion batteries.

### EXAMPLE 5

### Electrodes for Rechargeable Zinc/Air Batteries

Perovskite-type metal oxides (having an ABO₃ structure) are used as low cost, active electrocatalytic electrode materials in fuel cells and metal/air rechargeable batteries. Among these, Zn/air batteries have a desirable high energy/weight aspect ratio. During the charging process, ZnO is reduced to metallic Zn, while oxygen is released at the air electrode. In the discharging mode, oxygen from the air is reduced to OH, resulting in the formation of ZnO and water in the strong alkaline solution. Presently, efforts are focused on building an oxygen-electrode catalyst that will operate well in both anodic and cathodic modes of electrically rechargeable, air-based batteries, as well as in solid oxide fuel cell technologies. Up-to-date bifunctional air electrodes consist of perovskite powder, mixed with carbon black, resulting in a difference of some 800 mV between oxygen reduction and evolution. Recent work is focused on finding the best carbon-perovskite nanocomposite that is stable in strongly alkaline electrolyte, and which displays a homogeneously dispersed electrocatalyst (perovskite) on a conductive and stable carbon material. Carbonized cellulose beads according to the present invention can be used to provide such a conductive and stable carbon material.

### EXAMPLE 6

### Supercapacitors

### Electrochemical Capacitors for Energy Storage Systems

Supercapacitor systems are used in applications that require electrical energy at high power levels in a relatively short duration time. Based on the mode of energy storage, two types of the supercapacitors are used. One type depends on a double layer (dl) formation for charge separation; the other type depends on charge separation that is the result of a faradaic process of redox reactions. The former are called electrochemical dl capacitors, and latter are called pseudocapacitors. Both kinds of supercapacitors use carbon in various forms. In a (dl) type of supercapacitor, carbon serves as the conductive electrode, and in a pseudocapacitor, carbon is used as a support for the redox-active layer deposited on its surface. Recently, a third type of hybrid battery/supercapacitor has been developed where a positive, non-faradaic or pseudocapacitative electrode, based on carbon black, quickly and reversibly reacts with the anion from the electrolyte. The negative electrode is an insertion electrode that reversibly inserts or intercalates lithium atoms. The carbonized cellulose beads of the present invention can be used as electrode materials in these types of capacitors.

### EXAMPLE 7

### Electrodes for Fuel Cell Type Energy Generators

Currently, fuel cells appear to be the most efficient converters of chemical potential energy into a usable electrical and mechanical forms of energy used to power myriad applications that our highly developed, technology oriented society demands. Due to their high power-density performance at rather low temperatures (70° C. to 900° C.), fuel cells are considered to be the best alternative to serve as highly efficient energy sources for electric vehicles. In a basic type of fuel cell, the anodic gas stream is a hydrogen-reach gas that is in contact with an anode catalyst for the electrochemical oxidation of hydrogen. The most efficient anode catalyst consists of platinum and platinum alloy nanoparticles supported on a high surface area carbon (Pt/C). Carbon supports based on carbonized cellulose beads, such as Orbicell® carbon beads, can be incorporated into these applications.

### EXAMPLE 8

### Carbon as a Carrier for Heterogeneous Catalytic Nanomaterials

One of the challenging targets of organic synthesis is the development of new reactions and simplified procedures that allow easy conversion of simple starting compounds into complex molecules that may have a use as catalytic materials, therapeutic agents, or as molecules of theoretical importance. Especially challenging are processes on a large scale, such as those encountered in industrial environments and proportions. Most industrial reactions are of a catalytic nature, and vast improvements of many processes have involved applications of new catalysts and new catalytic schemes. A catalyst favorably alters the free energy of activation by becoming a part of an activated complex, consisting of starting material and final product molecules. Recent efforts in catalysis aim at aligning several distinct catalytic processes in situ, emulating quite common enzyme catalyzed reaction sequences. The catalysts used can be divided into the following two broad classes which, in large part, consist of transition metals and their compounds:
a) Catalysts insoluble in the reaction medium—heterogeneous catalysts (perhaps, the most common among these is a palladium-on-charcoal catalyst); and
b) Catalysts soluble in the reaction medium—homogeneous catalysts.

Carbonized cellulose beads of the present invention can be used as carriers for catalysts in many reactions depending on heterogeneous catalysts. The immediate focus is on heterogeneous catalysts comprising a carbon carrier for a variety of catalytically active nanoparticles on its surface. The spectrum of the reactions that may be catalyzed by such heterogeneous composite catalysts is very wide and the number of potential applications is extremely large. Carbonized cellulose beads, such as Orbicell® carbon beads, can be used as carriers of active catalytic moieties for particularly designed catalytic systems.

### EXAMPLE 9

### Storage of Hydrogen in Carbon Materials

When exposed to hydrogen, certain grades of amorphous, activated carbon have the ability to adsorb it tightly inside the nanopores. While their capacity for hydrogen storage is less than that of single-wall carbon nanotubes, the carbonized cellulose beads of the present invention can be used for hydrogen storage for fuel cell energy production. The addition of nanotubes to the surface of the carbon beads, particularly iron nanotubes, can be used to increase the capacity of the beads to store hydrogen.

### EXAMPLE 10

### Tribology

In many technical applications, small (1-2 micron), uniform, spherical particles that can take high pressure without breaking up can be used in a liquid oil or grease medium and behave like small, micron-sized, ball-bearings and as such, be able to prevent stiction and reduce friction and wear. This is another possible application of the carbonized cellulose beads of the present invention.

### EXAMPLE 11

### Solid Electrolyte Lithium-Ion battery

A commercially developed technology, available for licensing (Kimberly-Clark Corp., U.S. Pat. Nos. 5,736,473 and 6,294,222), provides a new and unique way to prepare uniformly distributed particles firmly attached to non-woven fibrous webs or fabrics. The preferred filament for the present application would be cellulose, particularly bacterial cellulose, with filaments being as thin as 0.1 micron (Oak Ridge National Laboratory). When a composite consisting of approximately 1 micron Orbicell® cellulose beads and of bacterial cellulose filaments is pyrolysed, an amorphous carbon-carbon composite web is obtained that would have an extremely large surface area for a non-porous material. Recent revival of a 70 year-old technology (see U.S. Pat. No.1,075,504) dealing with a process of electrospinning led to more than 50 new patents for making nano-filaments (ACS Polymer Preprints, 44(2): 51-176 (2003)). Carbon nano-filaments and corresponding non-woven fabrics have been disclosed as well. These filaments can be fused onto the surface of the carbonized cellulose beads of the present invention yielding material with the flexibility of fabric, the non-corrosiveness of polymers, and the conductivity of metals. In addition, interstitial spaces would be open to a minimum of 0.5 microns (one half of the diameter of the particles) allowing unobstructed contact between the electrolyte and electrodes made of such carbon-carbon composite.

A lithium-ion battery based on a solid electrolyte can be considered the most versatile and flexible device for storing electrical energy (charge). Since there is no liquid component among the parts comprising such a battery, any configuration is possible. The basic components, the enclosures, the leads, anodes, separators, solid electrolyte, and cathodes are layered over each other, allowing for the whole array to be shaped, molded and configured in such a way to conform with the contour of the object that will draw the charge. Such a lithium-ion battery can be used in any type of electrical device, electronic apparatus, vehicle, or any other electrically propelled machine. In other words, no special compartment or housing, like in presently used lead-acid batteries, is needed to effectively package all of the components in a minimum amount of space. Instead, the layered components can be molded and shaped into the object's “skin” or enclosure, into barriers, compartment dividers, chassis, or any other convenient space of the electrically powered object where it will not use up valuable space necessary for the intended purpose and functioning of the object.

1. A composition comprising carbonized cellulose beads of reconstituted cellulose, wherein the beads each have a surface area of about 4 m/g, an apparent density of between about 0.56 g/cm³ and about 0.58 g/cm³, and a specific gravity of less than about 2.

2. The composition of claim 1 wherein the carbonized cellulose beads further comprise metal, metal alloy, or metal oxide clusters attached to the surface of the beads.

3. The composition of claim 2 wherein the clusters further comprise a tin-antimony alloy.

4. The composition of claim 3 wherein the tin-antimony alloy clusters comprise at least about 50 percent by weight of the carbonized cellulose beads.

5. The composition of claim 3 wherein the tin-antimony alloy clusters comprise at least about 50 percent by weight of the carbonized cellulose beads.

6. The composition of claim 2 wherein the clusters further comprise iron.

7. The composition of claim 2 wherein the clusters further comprise a composition selected from the group consisting of iron, tin-antimony alloy, platinum, rhodium, palladium, nickel, and cobalt.

8. A method for producing carbonized cellulose beads comprising:
(a) providing reconstituted cellulose beads;
(b) drying the reconstituted cellulose beads; and
(c) pyrolyzing the reconstituted cellulose beads by heating the beads in an inert atmosphere at a temperature sufficient to pyrolyze the beads without causing significant crystallization of the beads.

9. The method of claim 8 wherein the reconstituted cellulose beads range from about 0.6 to about 2 microns in diameter, and are substantially free of pores on their surface.

10. The method of claim 8 wherein the reconstituted cellulose beads further comprise Orbicell® cellulose beads.

11. The method of claim 9 wherein the inert atmosphere is provided by streaming nitrogen gas over the beads while the beads are heated.

12. The method of claim 9 wherein the beads are heated to a temperature of not greater than about 650° C.

13. A composition comprising carbonized cellulose beads made according to the method of claim 8.

14. A composition comprising carbonized cellulose beads made according to the method of claim 9.

15. A composition comprising an anode material comprising carbonized cellulose beads.

16. The composition of claim 15 wherein the carbonized cellulose beads further comprise metal, metal alloy, or metal oxide clusters attached to the surface of the beads.

17. The composition of claim 16 wherein the clusters further comprise a tin-antimony alloy.

18. The method of using carbonized cellulose beads as an electrode material in a battery.

19. The method of claim 18 wherein the battery is selected from the group consisting of lithium-ion, magnesium-ion, and zinc/air batteries.
